(19) United States
(12) Patent Application Publication
(10) Pub. No.: US 2026/0249969 A1
(43) Pub. Date: Aug. 27, 2026

(54) OUTBOARD ELECTRIC MOTOR

(71) Applicant: ECOMAR PROPULSION LTD, Hampshire (GB)

(72) Inventors: Eugene Xavier BARI, Hampshire (GB); Anthony BENNETT, Hampshire (GB); Angelito BARBIERTO, Hampshire (GB); Malcolm PADWICK, Hampshire (GB)

(21) Appl. No.: 18/935,610

(22) PCT Filed: May 5, 2023
(86) PCT No.: PCT/IB2023/054713

§ 371 Date: Nov. 3, 2024

(30) Foreign Application Priority Data
May 6, 2022 (GB) 2206642.7

(51) Int. Cl. B63H 20/28; B63H 20/32; B63H 21/17; F01P 3/20

(52) U.S. Cl. CPC B63H 20/28; B63H 20/32; B63H 21/17; F01P 3/202; B63H 2020/323

(57) ABSTRACT

The modular marine outboard electric motor comprises: a motor housing which encloses an electric motor. The motor housing is adapted to connect to a drive shaft housing which encloses a drive shaft connected to a coupler.

The coupler is configured in use to transfer torque from the motor to the drive shaft. The drive shaft housing is adapted to connect to a gearbox housing which encloses a gearbox connected to an output shaft.

### FIELD

The present invention relates to an outboard electric motor, for example for use with a marine vessel. More particularly, but not exclusively, the invention relates to a modular outboard electric motor for a marine vessel which offers improved versatility and easy access for servicing.

### BACKGROUND OF INVENTION

Outboard motors require regular servicing to maintain efficient operation. Servicing can be complicated, costly and time consuming. There is a risk that complex electrical components may be damaged during servicing, for example as a result of accidental water exposure. Furthermore, components of the electric motor may need to be replaced when faulty.

There is also a need to replace spent energy supplies (such as rechargeable batteries) in modular systems which include integral battery packs or fuel cells which are housed in portions of the outboard motor or as standalone battery packs.

### PRIOR ART

International patent application number WO 2022/080771 (Nam) discloses an electric outboard motor with a removable electric motor.

United States patent application number US 2016/039510 (Shomura) describes an electric outboard motor which has an upper unit that is rotatable in a horizontal direction about a swivel unit. A lower unit is provided below the upper unit and is configured to function as a rudder. The upper unit comprises an electric motor supported by a rear side of the swivel unit via a mounting device.

Chinese utility model number CN-U-202138531 (SOLAS SCIENCE & ENGINEERING CO LTD) discloses an electric outboard motor, which is mounted at a rear of a vessel and includes an electric motor connected to an impeller of by two drive shafts to transmit power. When one of the drive shafts is driven by the electric motor, the impeller is driven by the other drive shaft to propel the vessel.

There is also a need for an outboard electric motor which is capable of being serviced and/or repaired efficiently and cost effectively.

### SUMMARY OF THE INVENTION

According to a first aspect of the present invention, there is provided a marine outboard electric motor comprising: a motor housing which encloses an electric motor; the motor housing is adapted to connect to a drive shaft housing, which encloses a drive shaft connected to a coupler, the coupler is configured in use to transfer torque from the motor to the drive shaft; and the drive shaft housing is adapted to connect to a gearbox housing which encloses a gearbox connected to an output, wherein the drive shaft housing has cooling channels therewithin which connect to cooling channels in the motor housing and to cooling channels in the gearbox housing; and the drive shaft housing, gearbox housing and motor housing each have self-sealing valves which are operative to seal the cooling channels when the drive shaft housing is disconnected from the motor housing and/or the gearbox housing.

The modular outboard electric motor of the present invention facilitates efficient servicing and repairing of the motor with reduced time and cost implications.

The drive shaft housing preferably comprises two or more cooling channels therewithin which lead to the motor housing.

The drive shaft housing is preferably adapted to connect to the gearbox housing by way of quick release connectors.

The one or more cooling channels in the drive shaft housing are operative to connect to one or more cooling channels in the motor housing when the two housings are connected.

The gearbox housing preferably has one or more cooling channels which are adapted to connect to the one or more cooling channels in the drive shaft housing.

At least two adjacent housings are preferably adapted to connect one to another by quick release couplings.

A closed cooling system is preferably defined by interconnected cooling channels when the drive shaft housing is connected to both the motor housing and the gearbox housing.

The outboard electric motor preferably further comprises a pump configured in use to circulate a coolant within the closed cooling system, for example through the interconnected cooling channels.

The outboard electric motor preferably includes a heat exchanger to improve removal of heat from the coolant.

In one embodiment, each of the motor housing and drive shaft housing may include self-sealing valves which are operative to seal each cooling channel when the motor housing is disconnected from the drive shaft housing.

Each of the drive shaft housing and gearbox housing has self-sealing valves which are operative to seal cooling channels when the drive shaft housing is disconnected from the gearbox housing and so prevent leakage of coolant into the sea or environment.

Self-sealing valves are preferably provided on both outward and return fluid pathways in the cooling channels.

A propulsion means, such as for example a propellor, may be connected to the output shaft.

The gearbox is preferably adapted to receive interchangeable gears to provide variable gear ratios.

The outboard electric motor preferably comprises a ventilation plate for improving performance.

In one embodiment, the outboard motor further includes a transom power coupling means.

The driveshaft housing and/or the gearbox housing preferably has a hydrodynamic casing.

The outboard motor may further comprise a sacrificial skeg to protect the base of the board motor upon impact. The skeg may for example comprise a fracture plane to facilitate sacrificial damage to the skeg during a collision.

The motor housing may comprise one or more LEDs configured to provide one or more visible indications to a user, for example, an “ON” LED and/or a navigation LED.

Housings may each be composed of any suitable material, for example carbon fibre and/or polymer.

The motor housing may in addition comprise a power supply, for example a rechargeable power supply. The housing may further comprise a recess configured to receive an interchangeable power supply.

The motor housing may comprise a user display configured to provide an indication as to the battery level.

The motor housing may be shaped to improve aerodynamic efficiency.

As the outboard electric motor is modular it will be appreciates that its components may be supplied separately.

Therefore according to a second aspect of the invention there is provided a motor housing that encloses an electric motor, the motor housing is adapted to connect to a drive shaft housing wherein the electric motor housing has cooling channels which connect to cooling channels in the drive shaft housing and self-sealing valves which are operative to seal the cooling channels in the motor housing when the motor housing is disconnected from the drive shaft housing.

According to a third aspect of the invention there is provided a drive shaft housing which encloses a drive shaft connected to a coupler, the coupler is configured in use to transfer torque from the motor to the drive shaft, the drive shaft housing is adapted to connect to a gearbox housing and to a motor housing, wherein the drive shaft housing has cooling channels which connect to cooling channels in the motor housing and to cooling channels in the gearbox housing; and self-sealing valves which are operative to seal the cooling channels in the driveshaft housing when the drive shaft housing is disconnected from the motor housing and/or the gearbox housing.

According to a fourth aspect of the invention there is provided a gearbox housing which is adapted to connect to a driveshaft housing and encloses a gearbox connected to an output, the gearbox housing has cooling channels which connect to cooling channels in the driveshaft housing and self-sealing valves which are operative to seal the cooling channels in the gearbox housing when the gearbox housing is disconnected from the drive shaft housing.

### BRIEF DESCRIPTION OF THE FIGURES

FIG. 1 is a schematic illustration of a side view of the modular marine outboard electric motor according to one embodiment of the present invention;

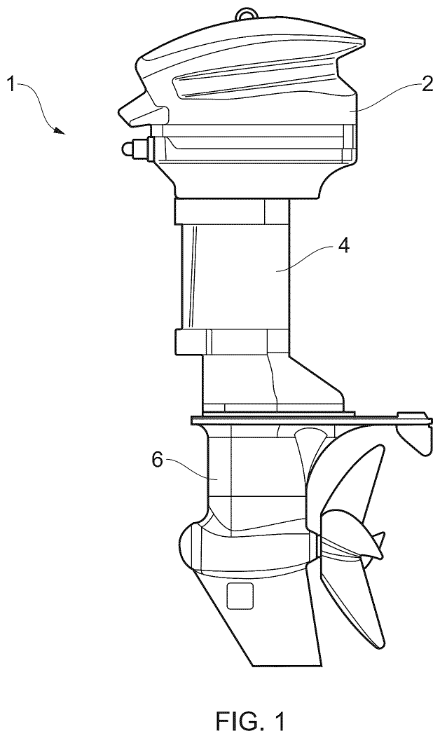

FIG. 2 is a schematic illustration of a side view of the motor housing of the modular marine outboard electric motor of FIG. 1;

FIG. 3 is a schematic illustration of a side view of the drive shaft housing of the modular marine outboard electric motor of FIG. 1; and

FIG. 4 is a schematic illustration of a side view of the gearbox housing of the modular marine outboard electric motor of FIG. 1.

### DETAILED DESCRIPTION OF PREFERRED EMBODIMENTS

With reference to the figures, the modular marine outboard electric motor 1 comprises three core modules: a motor housing 2, a drive shaft housing 4 and a gearbox housing 6. Each housing 2, 4, 6 houses the components that formulate an electric motor drive propulsion system. Optionally a replaceable battery housing may also be fitted to the outboard electric motor.

The marine outboard electric motor may be used on any suitable marine vessel.

Adjacent housings (motor) 2, (drive shaft) 4, (gearbox) 6 are adapted to connect one to another by quick release couplings such as clips or fasteners. The quick release couplings allow ease of servicing of one or more (or each) of the housings 2, 4, 6. The housings 2, 4, 6 each enclose and protect vulnerable electrical components from the end user. This arrangement therefore eliminates accidental spillage of coolant during end user maintenance and allows a degree of versatility in enabling variations of motor and gearbox rations to be employed within a single motor.

The housings are preferably watertight thereby preventing ingress of water.

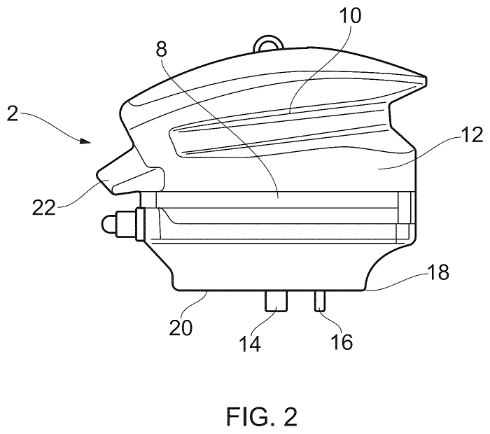

The motor housing 2, as shown in FIG. 2, comprises an interchangeable electric motor drive system 8 with a motor controller 10 and a closed loop cooling system. The closed loop cooling system comprises a plurality of cooling channels and a coolant pump 12. An output drive shaft 14 and coolant connection 16 protrude through a mating face 18 on a lower plane 20 of the housing 2. A coupler is configured in use to transfer torque from the motor drive system 8 to the drive shaft 14. Electrical couplings 22 are provided on the forward plane of the housing 2. The electric motor drive system 8, motor controller 10 and closed loop cooling system are self-contained within a sealed, waterproof enclosure.

The motor housing 2 (enclosing an electric motor) is connected to the drive shaft housing 4. In particular, the lower plane 20 of the housing provides a mating face 18 which is operable to couple to the drive shaft housing 4.

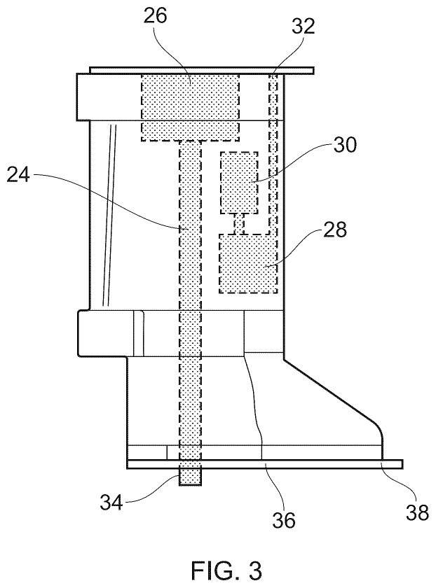

The drive shaft housing 4, as shown in FIG. 3, supports a single vertical drive shaft 24. The drive shaft housing 4 comprises an interchangeable gearbox 26, an internal coolant tank 28 (comprising a plurality of cooling channels), an internal expansion tank 30, a flush mounted sacrificial anode and heat exchanger combination and rear facing cavitation plate with stiffening ribs. The housing 4 comprises a cooling transfer plate on the wall of coolant tank 28.

The gearbox 26 is configured in use to be coupled to the output drive shaft 14 of the motor housing 2 by quick release mechanism for ease of separation. The gearbox 16 is connected to the output vertical drive shaft 24 by a quick release coupling allowing ease of removal of the gearbox for servicing and ration changing.

The coolant tank 28 employs at least one heat exchanger configured to enable natural cooling by the passage of seawater across the surface to maintain a coolant temperature. The heat exchangers can be double purposed with integrated sacrificial anodes.

The integral expansion tank 30 allows safety blow by from overheating whilst preventing spillage of coolant. The coolant is captured within the tank 30 which doubles as a baffle and only air is vented from the top of the expansion tank via a one-way valve.

The housing 4 further comprises an output drive shaft 34 which protrudes from the lower mating face 36 of the housing 4. An anti-cavitation plate 38 extends from the lower, rear section of the housing 4 to provide hydrodynamic efficiency for the propellor operation.

The coolant tank 28 connects to the motor housing 2 by a quick release mechanism 32 to interconnect with each other. The coolant quick release mechanism automatically seals upon disconnect to prevent spillage. Access into a housing is restricted to the end user) whereby removal from the mid-section is required to access anti-tamper fasteners which release the cover of the housing.

Each of the motor housing 2 and drive shaft housing 4 include self-sealing valves which are operative to seal each cooling channel when the motor housing 2 is disconnected from the drive shaft housing 4. The self-sealing valves are configured to prevent any spillage when the housings 2, 4 are disconnected from each other.

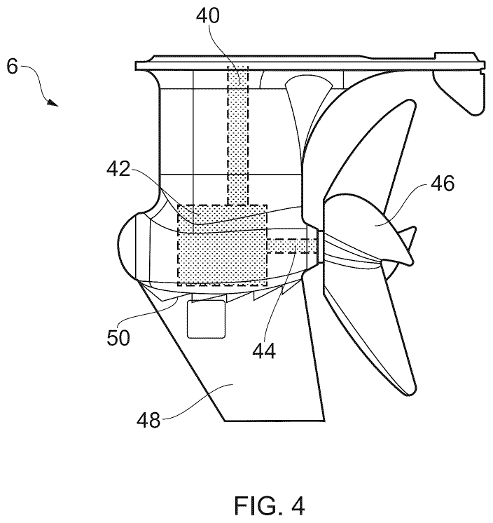

The gearbox housing 6, as shown in FIG. 4, comprises vertical drive shaft 40, a 90-degree interchangeable shaft gear box 42 in communication with a propellor output shaft 44 with propellor 46 and sacrificial skeg 48 at the lowermost point of the gearbox housing 6.

The vertical drive shaft 40, horizontal output shaft 44 and gearbox 42 are connected by quick release couplings. This allows ease of removal of the gearbox from the gearbox housing 6 for servicing and ration changing.

The skeg 48 protrudes downwardly having a designed-in fracture plane 50 rendering the skeg 48 as a sacrificial component upon collision. This arrangement provides additional protection to the rest of the outboard propulsion system 1. The remainder of the skeg 48 after breaking may be easily removed and replaced with a new skeg.

In use, the user may disconnect one or more of the motor housing, drive shaft housing and/or gearbox housing from each other, by disconnecting the quick release couplings for service or repair.

Each housing is water tight, thereby preventing accidental spillage onto internal components and reducing the risk of damage.

The user may quickly and efficiently disconnect an affected or damaged component, such as for example a gearbox, for cleaning or repair. Once repaired on cleaned, the original component may be replaced back into the housing. Alternatively, a replacement component may be inserted back into position within the housing.

The user may then reconnect the housing to the adjacent housing using the quick release couplings. The outboard electric motor is now ready for operation.

The modular marine outboard electric motor of the present invention is configured to enable efficient servicing and repair of the component modules with reduced risk of water ingress and damage to the components stored within the housing. The motor of the present invention may therefore be repaired or serviced quickly, reducing labour time and expense.

Furthermore, the motor of the present invention may be compatible with a variety of different gearboxes and/or motors to provide increased versatility dependent on particular conditions for the motor.

1. A marine outboard electric motor comprising: a motor housing which encloses an electric motor; the motor housing is adapted to connect to a drive shaft housing, which encloses a drive shaft connected to a coupler, the coupler is configured in use to transfer torque from the motor to the drive shaft; and the drive shaft housing is adapted to connect to a gearbox housing which encloses a gearbox connected to an output, wherein the drive shaft housing has cooling channels therewithin which connect to cooling channels in the motor housing and to cooling channels in the gearbox housing; and the drive shaft housing, gearbox housing and motor housing each have self-sealing valves which are operative to seal the cooling channels when the drive shaft housing is disconnected from the motor housing and/or the gearbox housing.

2. The outboard electric motor according to claim 1 wherein at least two adjacent housings are adapted to connect one to another by quick release couplings.

3. The outboard electric motor according to claim 2 wherein a closed cooling system is defined by interconnected channels when the drive shaft housing is connected to the motor housing and the gearbox housing.

4. The outboard electric motor according to claim 3 further comprising a pump for circulating a coolant within the closed cooling system.

5. The outboard electric motor according to claim 3 further comprising a heat exchanger to improve removal of heat from the coolant.

6. The outboard electric motor according to claim 1 wherein the self-sealing valves are provided on outward and return fluid pathways in the cooling channels.

7. The outboard electric motor according to claim 1 wherein a propulsion means is connected to the output shaft.

8. The outboard electric motor according to claim 1 wherein the gearbox is adapted to receive interchangeable gears to provide variable gear ratios.

9. The outboard electric motor according to claim 1 wherein the motor housing includes a ventilation plate for improving cooling.

10. The outboard electric motor according to claim 1 including a transom power coupling means.

11. The outboard electric motor according to claim 1 wherein the driveshaft housing and/or the gearbox housing has a hydrodynamic casing.

12. The outboard electric motor according to claim 1 includes a sacrificial skeg to protect the base of the outboard motor in the event of an impact or grounding.

13. A motor housing encloses an electric motor, the motor housing is adapted to connect to a drive shaft housing wherein the electric motor housing has cooling channels which connect to cooling channels in the drive shaft housing and self-sealing valves which are operative to seal the cooling channels in the motor housing when the motor housing is disconnected from the drive shaft housing.

14. A drive shaft housing which encloses a drive shaft connected to a coupler, the coupler is configured in use to transfer torque from the motor to the drive shaft, the drive shaft housing is adapted to connect to a gearbox housing and to a motor housing, wherein the drive shaft housing has cooling channels which connect to cooling channels in the motor housing and to cooling channels in the gearbox housing; and self-sealing valves which are operative to seal the cooling channels in the driveshaft housing when the drive shaft housing is disconnected from the motor housing and/or the gearbox housing.

15. A gearbox housing is adapted to connect to a driveshaft housing and encloses a gearbox connected to an output, the gearbox housing has cooling channels which connect to cooling channels in the driveshaft housing and self-sealing valves which are operative to seal the cooling channels in the gearbox housing when the gearbox housing is disconnected from the drive shaft housing.
